(19) United States
(12) Patent Application Publication
(10) Pub. No.: US 2013/0235462 A1
(43) Pub. Date: Sep. 12, 2013

(54) iP

(71) Applicant: Alfred M. Haas, Oakhurst, NJ (US)

(72) Inventor: Alfred M. Haas, Oakhurst, NJ (US)

(21) Appl. No.: 13/753,574

(22) Filed: Jan. 30, 2013

Related U.S. Application Data
(60) Provisional application No. 61/595,015, filed on Feb. 3, 2012.

(51) Int. Cl. G02B 5/00

(52) U.S. Cl. CPC G02B 5/003; G02B 5/00
USPC 359/614; 359/601

(57) ABSTRACT

The invention disclosed herein relates to methods and means for absorbing, attenuating, blocking, occluding, reflecting and/or otherwise filtering light, and/or for blocking transmission of a signal or disconnecting power. In some embodiments, methods and means of the invention are directed to absorbing, attenuating, blocking, occluding, reflecting and/or otherwise filtering light from reaching a sensing and/or transducing means, e.g., of a camera. In some embodiments, methods and means of the invention are directed to blocking the transmission of one or more signals and/or to disconnecting power from a sensing and/or transducing means or other component, e.g., of a camera.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. 61/595,015 (“the '015 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '015 provisional and expressly incorporates by reference the disclosures contained therein in their entirety, including but not limited to all patents, patent applications, and publications which are incorporated by reference in the '015 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system, etc . . . . Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: smart and other scales, thermostats, e-readers (e.g. Kindle™ and Nook™), hearing aids, laptop and desktop computers, alarms, smart phones, PDAs, other commercially available electronic devices such as tablet PCs, netbooks, pagers, beepers, cell phones, hearing aids, watches comprising integrated and/or discrete circuits, monitors and displays, televisions, calculators, iPods™ and MP3 players, radios and stereos, speakers, microphones, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, digital signal processors, memories, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, coils, radio frequency identification (“RFID”) devices, near-field communication (“NFC”) devices, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, etc . . . .

Examples of commercial-off-the-shelf hardware, including but not limited to processing units, displays, microphones, communications modules, sensors, and speakers, may be found on the DigiKey website, www.digikey.com, the Allied Electronics website, www.alliedelec.com, and the website www.globalspec.com. Details pertaining to hardware identified on these sites may be found in their associated sensor and product data sheets and published specifications.

Examples of commercially available chemicals, reagents and scientific equipment may be found on the Fisher Scientific website, www.fishersci.com, and the Sigma-Aldrich website, www.sigmaaldrich.com. Details pertaining to these items may be found in their associated product descriptions, published specifications and material safety data sheets.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, methods and other aspects of some embodiments of the disclosed invention—including, but not limited to, materials and compositions, software and hardware such as circuits, sensors and displays, housings, wearable and other mobile devices, optics, electrical and mechanical switches, electrical and mechanical regulators, etc.: Lange's Handbook of Chemistry, Fifteenth Edition, edited by John R. Dean, published by McGraw-Hill, copyright 1999; Hawley's Condensed Chemical Dictionary, Thirteenth Edition, revised by Richard J. Lewis, Sr., published by John Wiley & Sons, copyright 1997; Organic Chemistry, Third Edition, by G. Marc Loudon, published by The Benjamin/Cummings Publishing Company, copyright 1995; Chemical Separations and Measurements: The Theory and Practice of Analytical Chemistry, Dennis G. Peters, John M. Hayes, Gary M. Hieftje, published by W. B. Saunders Company, copyright 1974; Physical Chemistry, Seventh Edition, by Robert A. Alberty, published by John Wiley & Sons, copyright 1987; Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; Physics by Paul A. Tipler, published by Worth Publishers, copyright 1976; The New Way Things Work by David Macaulay, published by Houghton Mifflin, copyright 1988; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The invention disclosed herein relates to methods and means for absorbing, attenuating, blocking, occluding, reflecting and/or otherwise filtering light, and/or for blocking transmission of a signal or disconnecting power.

### BRIEF DESCRIPTION OF THE SEVERAL VIEWS OF THE DRAWINGS

FIGS. 1.A-1.C illustrate the application of specific examples of some embodiments of blind spots according to the instant invention.

FIGS. 2.A-2.G illustrate several examples of blind spots according to some embodiments of the invention.

FIG. 3 shows an example of an active blind spot according to some embodiments of the invention.

FIG. 4 illustrates a cut-away side view of a portion of a device being occluded by an example of an embodiment of a blind spot.

FIGS. 5.A-5.D illustrate an example of an embodiment of a case comprising a blind spot according to some embodiments of the instant invention.

FIG. 6 illustrates an example of an iPatch according to some embodiments of the instant invention.

FIG. 7 illustrates another example of an iPatch according to some embodiments of the instant invention.

FIG. 8 illustrates an example of an embodiment of the invention comprising a magnetizable blind spot.

FIG. 9 illustrates a specific example of an embodiment of a blind spot of the instant invention comprising a cap.

FIG. 10 illustrates a specific example of an embodiment of the invention comprising a switch which controls the transmission of an electrical signal from a light sensing means to a processing unit.

FIG. 11 illustrates a specific example of an embodiment of a blind spot comprising a mechanical shutter.

FIG. 12 is a photograph of examples of some embodiments of blind spots according to the instant invention.

FIG. 13 is a closer cropped photograph of the same examples of some embodiments of blind spots.

FIG. 14 is a photograph of a cell phone comprising an integrated camera with optics.

FIG. 15 is a photograph of cell phone comprising integrated camera with optics which are covered by an example of an embodiment of a blind spot.

FIG. 16 is a photograph of another view of a region of cell phone comprising integrated camera with optics which are covered by an example of an embodiment of a blind spot.

FIG. 17 is a photograph of another view of a region of cell phone comprising integrated camera with optics which are covered by a partly reflective example of an embodiment of a blind spot.

### DETAILED DESCRIPTION OF THE INVENTION

The invention disclosed herein relates to methods and means for absorbing, attenuating, blocking, occluding, reflecting and/or otherwise filtering light, and/or for blocking transmission of a signal or disconnecting power.

Although it is not believed that drawings are necessary for the understanding of the subject matter sought to be patented, for illustrative purposes we have included several figures related to specific examples of embodiments of the disclosed invention.

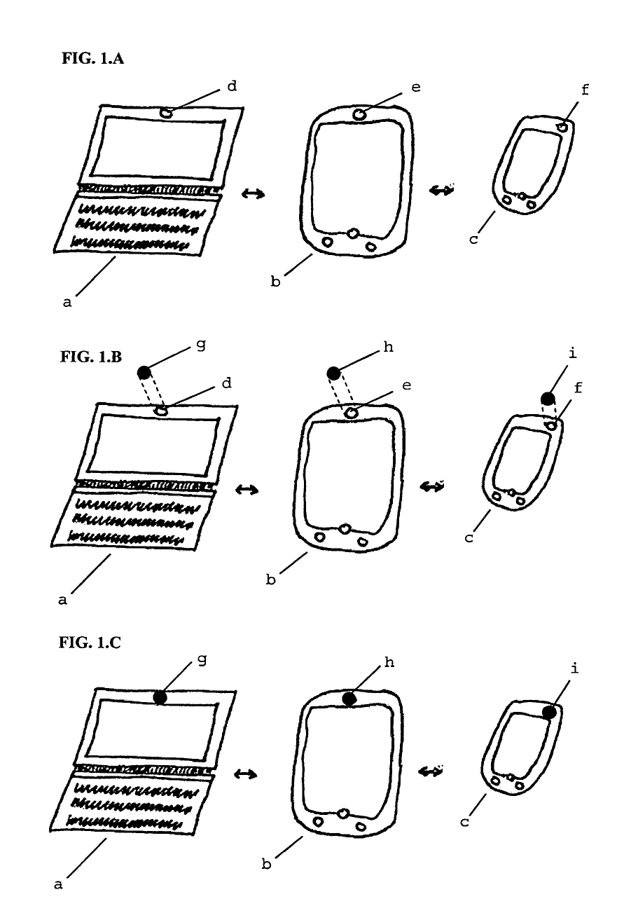

FIGS. 1 through 16 illustrate specific examples pertaining to some embodiments of means and methods of the instant invention. In FIG. 1.A a laptop computer, (a), a tablet PC, (b), and a cellular telephone, (c), having respective unshuttered cameras, (d), (e), and (f) are represented. FIG. 1.B illustrates the application of specific examples of blind spots, (g), (h), and (i) to the hardware according to some embodiments of the instant invention, and FIG. 1.C shows the laptop, the tablet PC, and the cell phone with examples of some embodiments of removable blind spots attached.

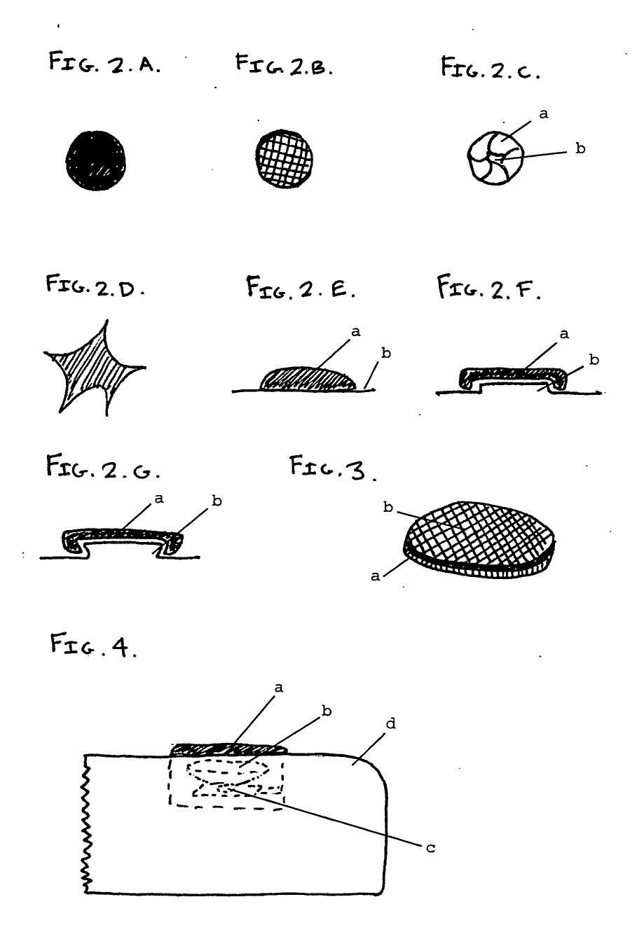

FIG. 2 illustrates several examples of blind spots according to some embodiments of the invention. FIG. 2.A illustrates a top-down view of a substantially circular polymer disc according to one example of an embodiment of the invention. FIG. 2.B illustrates a top-down view of a blind spot comprising a grid filter according to one example of an embodiment of the invention. In this specific example, the blind spot is substantially transparent, except that an optically opaque mesh grid of material has been embedded in the blind spot. In some embodiments, a grid or other pattern may be embedded in a blind spot, painted, printed or otherwise marked on a surface of a blind spot, and/or etched or otherwise formed onto or into a blind spot. FIG. 2.C illustrates a top-down view of example of an embodiment of a blind spot comprising an mechanical filter having aperture, (b), whose size is determined by the position of blades, (a), in this case, controlled by unseen motors, hardware and software. FIG. 2.D represents a top-down view of a free-hand star design for a blind spot according to an embodiment of the instant invention. FIG. 2.E illustrates a cut-away side view of a blind spot, (a), according to one embodiment of the invention, adhered to surface, (b). FIG. 2.F illustrates a cut-away side view of a blind spot comprising a cap, (a), according to one embodiment of the invention, disposed about and adhered to partially raised surface, (b). FIG. 2.G illustrates a cut-away side view of a blind spot, (a), according to one embodiment of the invention, disposed about and secured to surface, (b).

FIG. 3 shows an example of an active blind spot according to some embodiments of the invention comprising housing and attachment means, (a), and means for absorbing, attenuating, blocking, occluding, reflecting and/or otherwise filtering light, (b). In this specific example, the means for means for absorbing, attenuating, blocking, occluding, reflecting and/or otherwise filtering light comprises a liquid crystal device, a processing unit, a power supply and a communications module.

In some embodiments of the invention, a processing unit may comprise a microcontroller. In some embodiments, a processing unit may comprise one or more of a display driver, speaker drivers, input channels, power conditioning circuits, memory, and power supply regulation circuitry. In some embodiments, a processing unit may comprise hardware and/or software for performing other functions including but not limited to communicating and/or interfacing with other circuits, components, devices, systems, networks and individuals, processing and transmitting data, processing and transmitting power, controlling and/or operating other hardware and/or software, storing and retrieving data, receiving and decoding voice or other commands, generating signals including but not limited to text, graphics, and speech, as well as for such miscellaneous functions as, e.g. waking and sleeping. In some embodiments, a processing unit comprises custom integrated circuits; in some embodiments a processing unit comprises discrete circuits. In some embodiments, a processing unit comprises a combination of hardware and/or software.

In some embodiments of the invention, a processing unit may comprise a communications module—for example, a transceiver for communicating with other circuits, components, devices, systems, networks and individuals using electromagnetic (“EM”) waves. In some embodiments, a communications module may be used to transmit and receive data including for example but not limited to a detected event, a sensed signal, digital GPS coordinates, sound samples, images, to receive information from an input device such as a bar code reader, or scanner such as a cell phone bar code reader, and/or to retrieve firmware and software updates, as well as other data (e.g., the time and date). In some embodiments, a communications module may comprise an antenna and/or coil for transmitting and/or receiving EM signals. In some embodiments a communications module may be integrated with a processing unit; in some embodiments a communications module may comprise a separate component that may in some embodiments communicate with a processing unit. In some embodiments a communications module may communicate wirelessly along one or more wavelengths of the electromagnetic spectrum, including but not limited to, radio waves, IR, and visible light (e.g. via radio transceiver, IR transceiver, other coded and/or modulated light transmissions, etc . . . ). In some embodiments a communications module may communicate via wires, for example using one of a variety of USB cables. In some embodiments a communications module may include speakers and/or microphones and associated circuits for receiving and decoding voice commands and for generating sounds, including but not limited to speech. In some embodiments, a communications module may be integrated with a power supply—for example by capturing, harvesting and/or storing ambient or transmitted energy from an EM signal. In some embodiments, rechargeable batteries may be charged using the energy harvested from EM signals. In some embodiments, a communications module may comprise a transmission means comprising one or more lights, including but not limited to arrays of lights such as an LCD or LED display. For example, some embodiments comprise OLED (organic light emitting diode) displays like those found in modern cell phones and tablet PCs. However, as used in the context of this disclosure, embodiments of displays are not intended to be limited to a single or even to existing technology—additional examples of displays comprised, but are not limited to, the following: liquid crystals, thin film transistors, incandescent lights, fluorescent lights, halogen lights, light emitting diodes, organic light emitting diodes, lasers, fiber optics, color-changing polymers, pigmented fluids, solutions and mixtures, functionalized micro-beads, and e-inks.

In some embodiments, a power supply may comprise a battery holder and/or batteries, which batteries may in some embodiments be rechargeable. Additional illustrative examples of a power supply include, but are not limited to, solar cells and associated charging circuitry, a plug for receiving wall power with or without associated circuitry (such as electrical transformers, rectifiers, voltage regulators, capacitors, etc.), an inductive power receiver element (such as a coil and circuitry to receive inductively coupled power), an electromechanical generator (think self-winding watch), a thermal and/or electromechanical generator (think MEMS/NEMS generators), and any other suitable source of power.

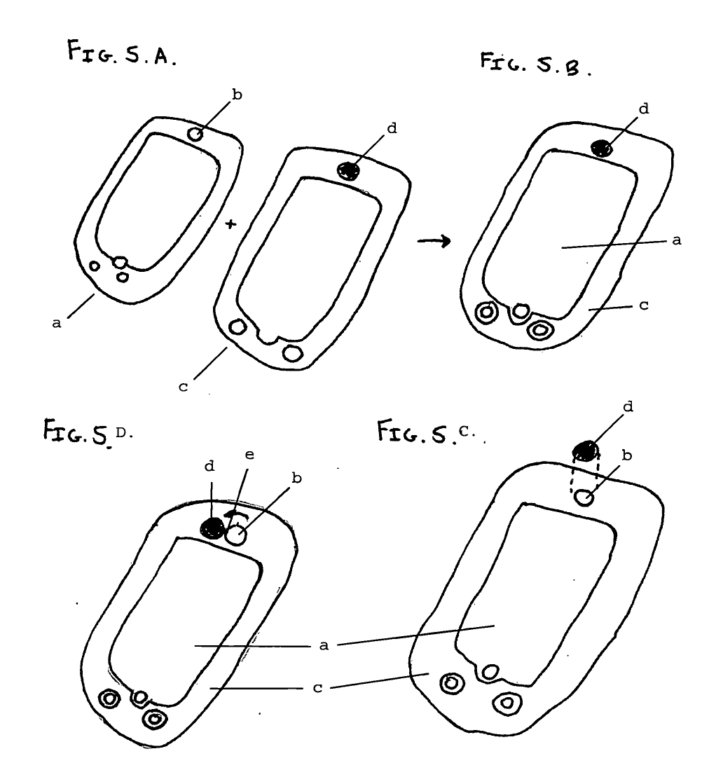

FIG. 4 illustrates a cut-away side view of a portion of a device, (d), comprising integrated optics, (b), and image sensing means, (c), being occluded by an example of an embodiment of a blind spot, (a), adhered to a surface proximate to and covering said optics.

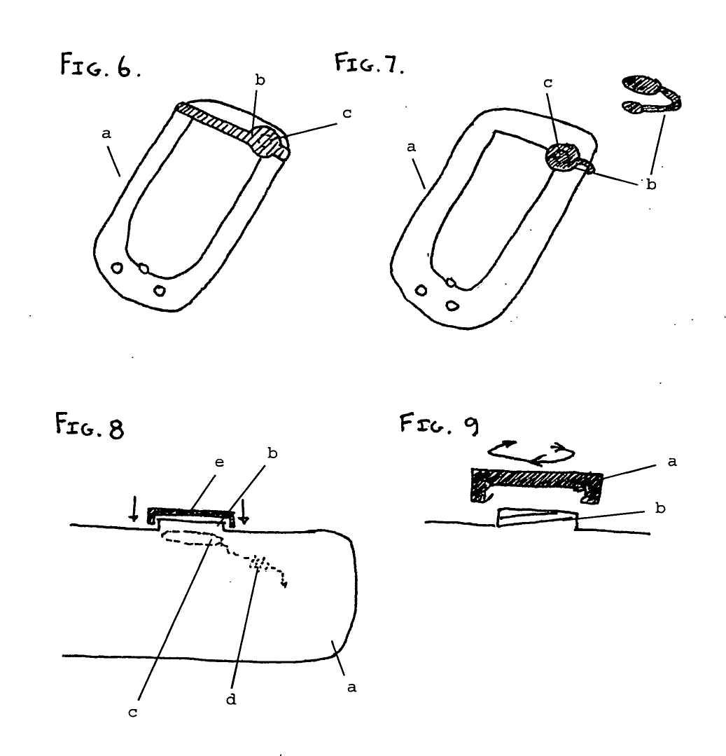

FIG. 5 illustrates an example of an embodiment of a cell phone case, (c), comprising blind spot, (d). As shown in FIGS. 5.A and 5.B of this specific example, when cell phone, (a), is placed into case, (c), the light sensing means of integrated cell phone camera, (b), is occluded by integrated blind spot, (d). FIGS. 5.C and 5.D illustrate two ways in which blind spots may be removed according to some embodiments of the instant invention. In FIG. 5.C, blind spot, (d), is simply peeled off case, (c); in FIG. 5.D, blind spot, (d), which may be a part of and/or attached to the case, (c), e.g. via material, (e), is folded back onto case,(c) to permit unimpeded operation of camera, (b). The “OR” in the figure is not intended to limit the invention in any way.

FIG. 6 illustrates an example of an iPatch according to some embodiments of the instant invention. In FIG. 6, an iPatch comprising an elastic band, (b), is disposed about a region of cell phone, (a), so that light sensing means of integrated camera, (c), is occluded. In this specific example, the iPatch is held in place by the tension in the elastic band and the corresponding forces, e.g. compression, frictive, generated when it is placed around the cell phone.

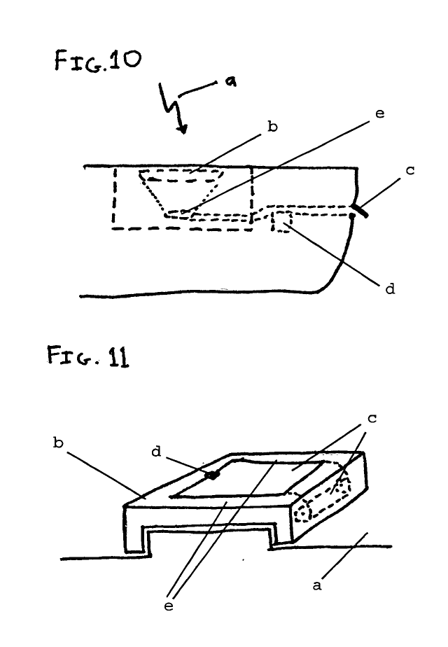

FIG. 7 illustrates an example of an iPatch according to some embodiments of the instant invention. In FIG. 7, the iPatch comprises a semi-rigid clip having a slot and a pair of inner surfaces formed so that the distance or gap between the inner surfaces is smaller, in one or more regions, than the thickness of a region of the illustrated cell phone, (a), comprising integrated camera, (c). In this specific example, when the inner surfaces of the clip are disposed, or slid, over the camera, regions of the inner surfaces of the clip experience a force from surfaces of the device pressing against them and this pressure torsions a portion of the clip connecting the surfaces, which exerts a proportional compressive pressure or force against the device to hold it securely in place.

FIG. 8 illustrates an example of an embodiment of the invention comprising a magnetizable blind spot, (e), which may be detachably secured to surface, (b), of device, (a), using electromagnet, (c), powered by battery, (d).

FIG. 9 illustrates a specific example of an embodiment of a blind spot of the instant invention comprising threaded cap, (a), which may be detachably screwed onto threaded surface, (b).

FIG. 10 illustrates a specific example of an embodiment of the invention comprising switch, (c), which controls the transmission of an electrical signal from light sensing means, (e), to processing unit, (d), comprising a communications module (not shown). In this specific illustration, irrespective of whether light, (a), passes through optics, (b), and is detected and/or transduced by light sensing means, (e), no signal or image will be communicated unless switch, (c), is closed.

FIG. 11 illustrates a specific example of an embodiment of a blind spot, (b), comprising a mechanical shutter, (c), having handle, (d), which blind spot is removably attached to surface, (a). In this specific example, the mechanical shutter slides along guide rails, (e).

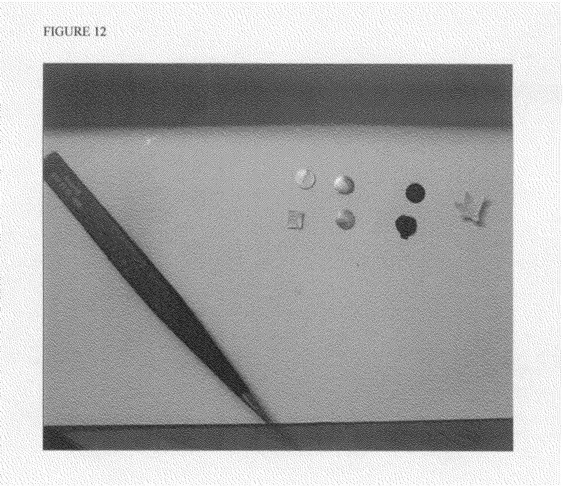

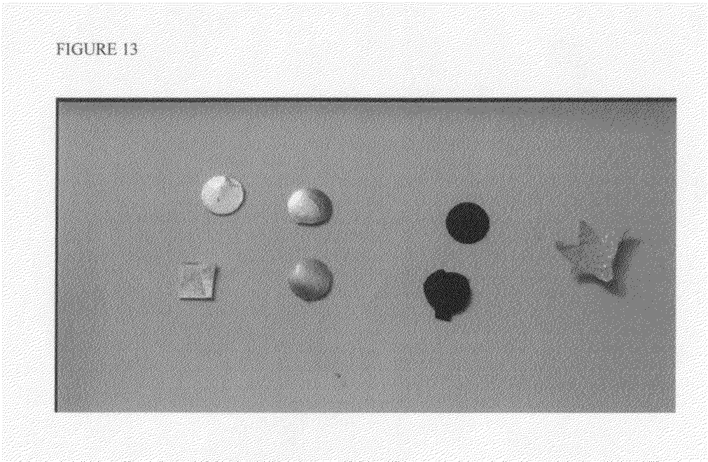

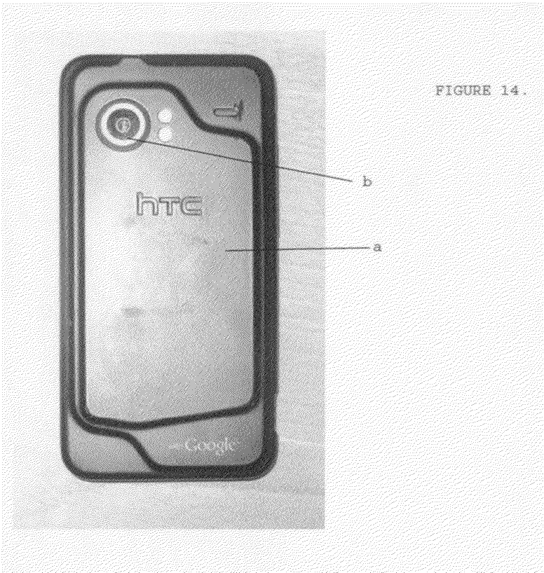

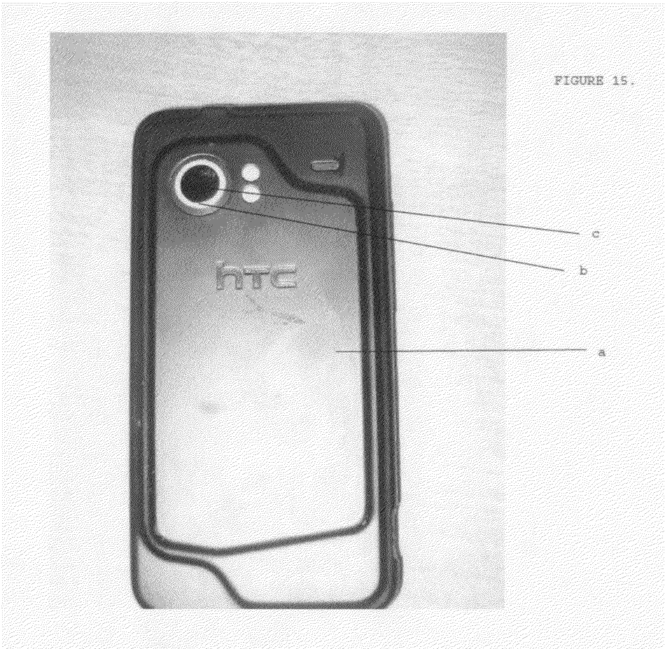

FIG. 12 is a photograph of several examples of some embodiments of blind spots according to the instant invention, and also of a tweezer which does not comprise a blind spot. FIG. 13 is a closer cropped photograph of the same examples of embodiments of blind spots.

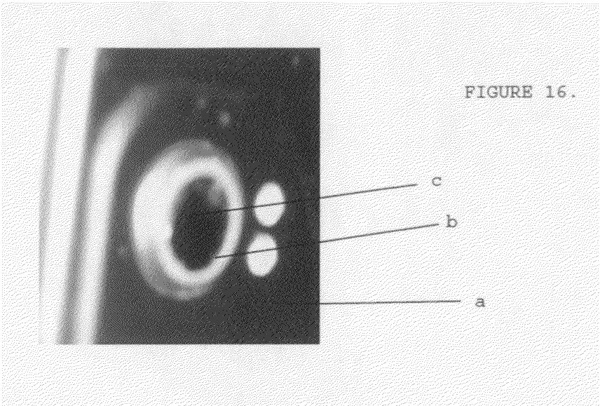

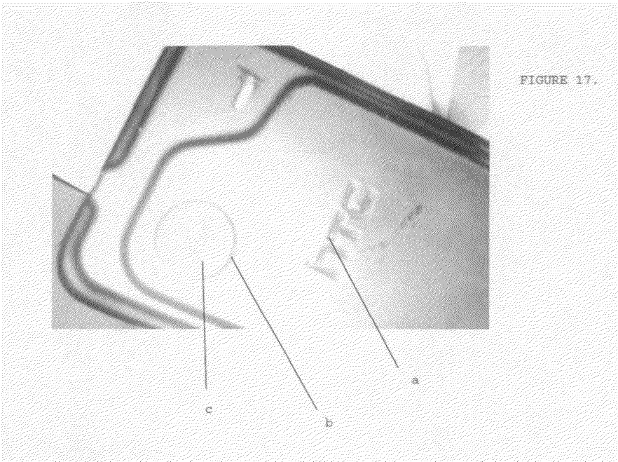

FIG. 14 is a photograph of a cell phone, (a), comprising an integrated camera with optics, (b). FIG. 15 is a photograph of cell phone, (a), comprising integrated camera with optics, (b), which are covered by an example of an embodiment of a blind spot, (c). FIG. 16 is a photograph of another view of a region of cell phone, (a), comprising integrated camera with optics, (b), which are covered by an example of an embodiment of a blind spot, (c). FIG. 17 is a photograph of another view of a region of cell phone, (a), comprising integrated camera with optics, (b), which are covered by a partly reflective example of an embodiment of a blind spot, (c). In this photograph, the example of the embodiment of a blind spot, (c), is one of the silver examples of an embodiment of a blind spot shown in FIGS. 12 and 13.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application or scope of the appended claims. All publications, patents, and patent applications cited herein are hereby incorporated by reference in their entirety.

I claim:

1. An apparatus for absorbing, attenuating, blocking, occluding, reflecting and/or otherwise filtering light, and/or for blocking transmission of a signal or disconnecting power.

2. A means comprising hardware for absorbing, attenuating, blocking, occluding, reflecting and/or otherwise filtering light, and/or for blocking transmission of a signal or disconnecting power.

3. A method for absorbing, attenuating, blocking, occluding, reflecting and/or otherwise filtering light, and/or for blocking transmission of a signal or disconnecting power.

4. The method of claim 3 wherein one or more steps of the method involves the use of hardware comprising one or more of a cell phone, a tablet computer, a worn device comprising a microprocessor, and a personal digital assistant.
